(19) United States
(12) Patent Application Publication
(10) Pub. No.: US 2008/0284683 A1
(43) Pub. Date: Nov. 20, 2008

(54) Plasma display device and the method for driving the display

(76) Inventors: Sang-Young Lee, Suwon-si (KR); Kwang- Ho Jin, Suwon-si (KR); Jung-Jin Choi, Suwon-si (KR)

Correspondence Address: ROBERT E. BUSHNELL, 1522 K STREET NW, SUITE 300, WASHINGTON, DC, 20005-1202, US

(21) Appl. No.: 12/081,213

(22) Filed: Apr. 11, 2008

(30) Foreign Application Priority Data
May 18, 2007 (KR) 10-2007-0048713

(51) Int. Cl. G09G 3/28

(52) U.S. Cl. 345/60; 345/63; 345/68; 345/690

(57) ABSTRACT

In a plasma display device, one frame is divided into a plurality of subfields, each having a weight, a first subfield to which more than a reference number of sustain pulses are allocated among the plurality of subfields is detected, at least N first sustain pulses are applied to the plasma display device during a sustain period of the first subfield, and at least M second sustain pulses are applied to the plasma display device during a sustain period of the first subfield. The first and second sustain pulses respectively have a high level voltage and a low level voltage, and a first period during which the first sustain pulse is changed from the low level voltage to the high level voltage is longer than a second period during which the second sustain pulse is changed from the low level voltage to the high level voltage.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on 18 May 2007 and there duly assigned Serial No. 10-2007-0048713.

### BACKGROUND OF THE INVENTION

1. Field of the Invention

The present invention relates to a plasma display device and a driving method thereof.

2. Description of the Related Art

A plasma display is a flat panel display that uses plasma generated by gas discharge to display characters or images. It includes, depending on its size, more than several scores to millions of discharge cells (hereinafter referred to as “cells”) arranged in a matrix pattern.

One frame of such a plasma display is divided into a plurality of subfields having weight values, and a grayscale of each cell is represented by a sum of weight values of subfields in which the corresponding cells emit light, among the plurality of subfields. Each subfield includes a reset period, an address period, and a sustain period. The reset period is a period of initializing a state of each cell, and the address period is a period of selecting a cell to emit light among a plurality of cells through an addressing operation. The sustain period is a period of displaying an image by applying a sustain pulse so as to generate a sustain discharge in the cell, which was set to emit light in the address period. In this case, luminance represented by each cell is determined by the number of sustain pulses applied during the sustain period in the plasma display device.

When a small number of sustain pulses are applied to the cell, the luminance of the cell increases in proportion to the number of sustain pulses. However, when a large number of sustain pulses are applied to the cell, the luminance of the cell is not increased in proportion to the number of sustain pulses as time passes due to a light saturation phenomenon of a phosphor coated over an address electrode.

That is, when the number of sustain pulses allocated to a sustain period of one subfield is greater than a reference number, the luminance of the subfield is not linearly increased. Therefore, when the plasma display device displays an image, luminance cannot be appropriately represented by using only the number of sustain pulses allocated to each subfield with a constant ratio. In addition, a grayscale inversion phenomenon may occur and thus luminance of a cell having a high grayscale may be represented lower than that of a cell having a low grayscale.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display device having advantages of properly representing luminance in proportion to the number of sustain pulses that corresponds to a weight of a subfield, and a driving method thereof.

An exemplary driving method according to one embodiment of the present invention drives a plasma display device that divides one frame into a plurality of subfields, each having a weight. The driving method includes: detecting a first subfield allocated with more than a reference number of sustain pulses during a sustain period among the plurality of subfields; applying at least N first sustain pulses to the plasma display device during the sustain period of the first subfield (where N is a natural number greater than 1); and applying at least M second sustain pulses to the plasma display device during the sustain period of the first subfield (where M is a natural number greater than 1). The first and second sustain pulses alternately have a first voltage and a second voltage that is greater than the first voltage. The first sustain pulse is increased to a third voltage that is less than the second voltage from the first voltage during a first period, and then maintained at the second voltage during a second period. The second sustain pulse is increased to a fourth voltage that is less than the second voltage from the first voltage during a third period, and then maintained at the second voltage during a fourth period. The third period is shorter than the first period.

An exemplary plasma display device according to another embodiment of the present invention includes a plasma display panel (PDP), a controller, and a driver. The PDP has a first electrode and a second electrode that performs a sustain discharge operation with the first electrode. The controller divides one frame into a plurality of subfields, and detects a first subfield to which more than a reference number of sustain pulses are allocated among the plurality of subfields. The driver applies at least N first sustain pulses (where N is a natural number greater than 1) to the PDP and applies at least M second sustain pulses (where M is a natural number, greater than 1) to the PDP during a sustain period of the first subfield by control of the controller. The first and second sustain pulses respectively have a high level voltage and a low level voltage, and a first period during which the first sustain pulse is changed from the low 11 level voltage to the high level voltage is longer than a second period during which the second sustain pulse is changed from the low level voltage to the high level voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a top plan view of a plasma display device according to an exemplary embodiment of the present invention.

FIG. 2 is a driving waveform of the plasma display device according to the exemplary embodiment of the present invention.

FIG. 3 is a block diagram of a controller according to the exemplary embodiment of the present invention.

FIG. 4A and FIG. 4B show a sustain pulse according to the exemplary embodiment of the present invention.

FIG. 5 shows a sustain driver that generates a sustain pulse according to the exemplary embodiment of the present invention.

FIG. 6A and FIG. 6B show driving timing of a driving circuit that generates a sustain pulse according to the exemplary embodiment of the present invention.

FIG. 7A and FIG. 7B show current paths for generating the sustain pulse according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

Wall charges mentioned in the following description mean charges formed and accumulated on a wall (e.g., a dielectric layer) close to an electrode of a discharge cell. The wall charge will be described as being “formed” or “accumulated” on the electrode, although the wall charges do not actually touch the electrodes. Further, a wall voltage means a potential difference formed on the wall of the discharge cell by the wall charge.

Throughout this specification and the claims that follow, when it is described that an element is “coupled” to another element, the element may be “directly coupled” to the other element or “electrically coupled” to the other element through a third element.

A plasma display device and a driving method thereof according to an exemplary embodiment of the present invention will now be described in further detail with reference to the accompanying drawings.

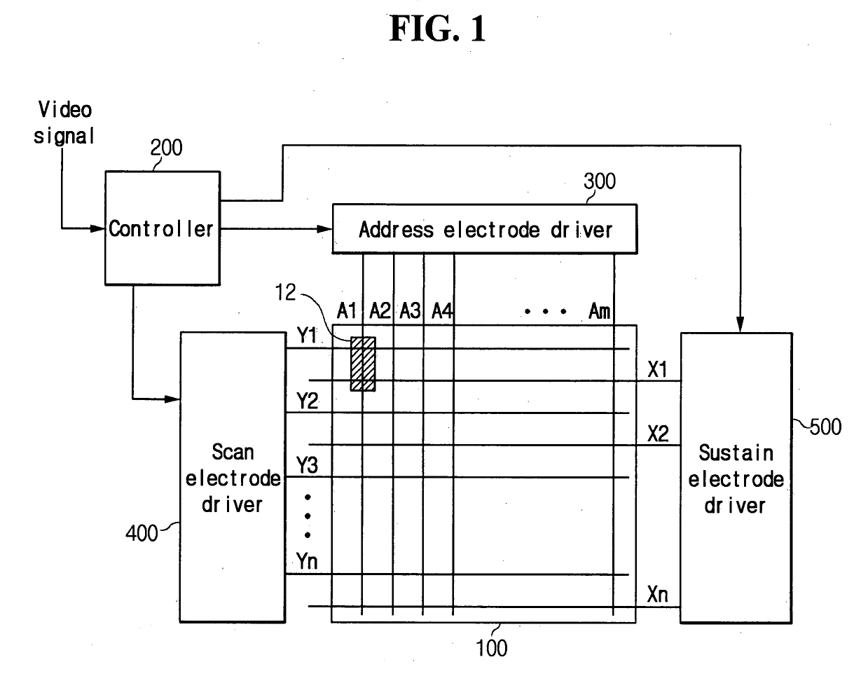

FIG. 1 is a top plan view of a plasma display device according to an exemplary embodiment of the present invention.

As shown in FIG. 1, the plasma display device according to the exemplary embodiment of the present invention includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction as pairs. Hereinafter, the address electrode, the sustain electrode, and the scan electrode will be respectively referred to as an A electrode, an X electrode, and a Y electrode. The plurality of Y electrodes Y1 to Yn and X electrodes X1 to Xn are arranged so as to be arranged in pairs. Discharge cells 12 are formed at intersections of adjacent Y electrodes Y1 to Yn and X electrodes X1 to Xn, and the A electrodes A1 to Am.

The controller 200 externally receives video signals (i.e., R, G, and B data) and outputs an address electrode driving control signal, a sustain electrode driving control signal, and a scan electrode driving control signal to the address electrode driver 300, the scan electrode driver 400, and the sustain electrode driver 500, respectively. In addition, the controller 200 controls one frame to be divided into a plurality of subfields, each having a weight. In this case, each subfield includes a reset period, an address period, and a sustain period with respect to time. The controller 200 according to the exemplary embodiment of the present invention controls a subfield to which more than a reference number of sustain pulses are allocated among the plurality of subfields to be applied with a sustain pulse that compensates luminance deterioration due to light saturation of the subfield.

The address electrode driver 300 receives the address electrode driving control signal from the controller 200 and applies signals for selecting discharge cells to be displayed to the respective A electrodes A1 to Am.

The scan electrode driver 400 receives the scan electrode driving control signal from the controller 200 and applies a driving voltage to the Y electrodes Y1 to Yn.

The sustain electrode driver 500 receives the sustain electrode driving control signal from the controller 200 and applies a driving voltage to the X electrodes X1 to Xn.

In the following description, a plasma display device for properly representing desired-luminance according to an input signal, and a driving method thereof, will be described in further detail.

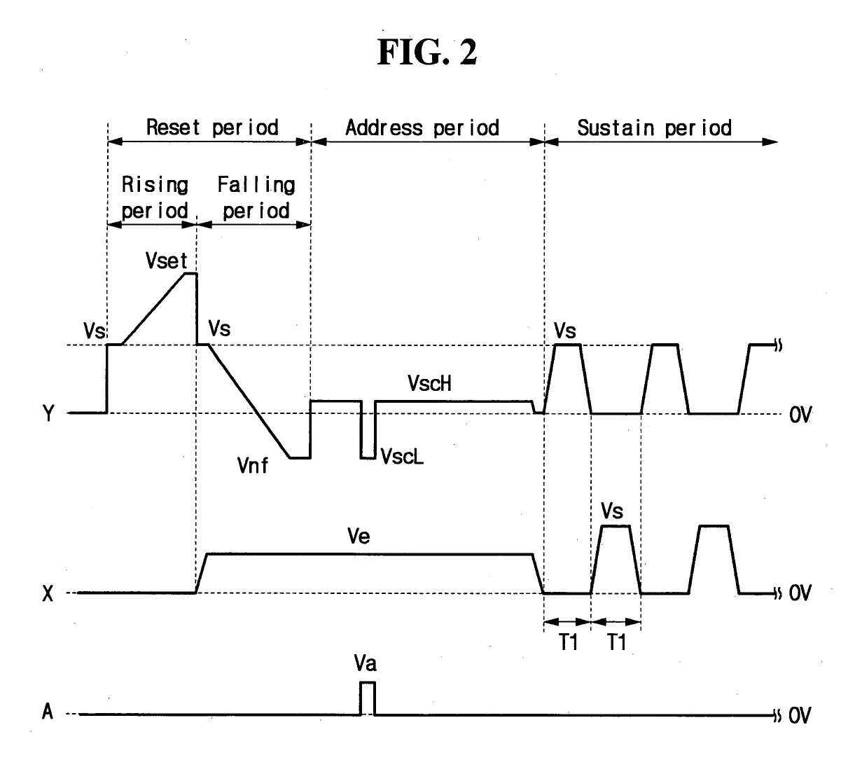

FIG. 2 is a driving waveform of the plasma display device according to the exemplary embodiment of the present invention.

In FIG. 2, a driving waveform applied to the A electrode, the X electrode, and the Y electrode forming one cell will be described for better understanding and ease of description.

As shown in FIG. 2, in a rising period of a reset period, a voltage of the Y electrode is gradually increased from a Vs voltage to a Vset voltage while the X electrode and the A electrode are applied with a reference voltage (0V in FIG. 2). While the voltage of the Y electrode is gradually increased, a weak discharge is generated between the Y electrode and the X electrode and between the Y electrode and the A electrode so that negative (−) wall charges are formed on the Y electrode and positive (+) wall charges are formed on the A electrode. In this case, since the same level of wall voltages is not generated between the respective electrodes in the plurality of cells, the Vset voltage is set to be high enough to cause generation of a discharge in all the cells regardless of wall charges formed in the cells. In general, the Vset voltage is twice the discharge firing voltage between the X electrode and the Y electrode.

After that, in a falling period of a reset period, the voltage of the Y electrode is gradually decreased to a Vnf voltage from the Vs voltage while the reference voltage and a Ve voltage are respectively applied to the A electrode and the X electrode. Then, a weak discharge is generated between the Y electrode and the X electrode and between the Y electrode and the A electrode while the voltage of the Y electrode is gradually decreased, and accordingly, the negative (−) wall charges formed on the Y electrode Y and the positive (+) wall charges formed on the A electrode are erased for an addressing operation. In this case, a (Vnf-Ve) voltage is set to close to a discharge firing voltage Vfxy between the Y electrode and the X electrode.

Subsequently, in an address period, a scan pulse having a scan voltage (VscL voltage in FIG. 2) is sequentially applied to the plurality of Y electrodes while the Ve voltage is applied to the X electrode so as to select a turn-on cell (i.e., a cell to be turned on). An address pulse having an address voltage (Va voltage in FIG. 2) is applied to an A electrode that passes a cell to emit light among the plurality of cells formed by the Y electrode Y and the X electrode X to which the VscL voltage is applied. Then, an address discharge is generated between the A electrode to which the Va voltage is applied and the Y electrode to which the VscL voltage is applied. Subsequently, the address discharge is consecutively generated between the X electrode and the Y electrode that pass the cell that has experienced the address discharge between the A electrode and the Y electrode. Then, positive (+) wall charges are formed on the Y electrode and negative (−) wall charges are formed on the A electrode. In this case, a VscH voltage (non-scanning voltage) that is higher than the VscL voltage is applied to the Y electrode to which the VscL voltage is not applied, and the reference voltage is applied to the A electrode of the unselected discharge cell.

In a sustain period, a sustain pulse of opposite phases, which has a high level voltage (the Vs voltage in FIG. 2) and a low level voltage (the 0V voltage in FIG. 2), is applied to the Y electrode and the X electrode. In this case, it is illustrated in FIG. 2 that the high level voltage and the low level voltage of the sustain pulses are respectively applied to the Y and X electrodes for a period T1. That is, when the first sustain pulse is applied, the high level voltage (i.e., Vs voltage) is applied to the Y electrode and the low level voltage (i.e., 0V) is applied to the X electrode during the period T1 so that a voltage difference between the Y and X electrodes and becomes the Vs voltage. In addition, when the second sustain pulse is applied, the low level voltage of the 0V is applied to the Y electrode and the high level voltage of the Vs voltage is applied to the X electrode during the period T1 so that the voltage difference between the Y and X electrodes is maintained at the Vs voltage. As described, the voltage difference between the Y and X electrodes is maintained at the Vs voltage when each sustain pulse is applied. Then, a sum of the wall voltage formed in a turn-on cell selected in the previous address period and the voltage difference Vs between the Y electrode and the X electrode becomes greater than the discharge firing voltage so that a sustain discharge is generated between the Y electrode and the X electrode and a negative (−) wall voltage is formed on the Y electrode and a positive (+) wall voltage is formed on the X electrode. In a manner like the above, a process of applying the sustain pulse to the Y electrode and the X electrode is repeated a number of times that corresponds to a weight of the corresponding subfield.

Generally, a plasma display device is driven by dividing one frame into a plurality of subfields. In addition, a different number of sustain pulses are applied to each subfield according to a weight thereof. The following Table 1 exemplarily shows one frame divided into eight subfields. In addition, it is assumed that a weight ratio of the first to eighth subfields SF1 to SF8 is 1:2:4:8:16:32:64:128. In addition, Table 1 exemplarily shows the number of sustain pulses applied to each subfield according to a weight thereof.

TABLE 1

| Subfield | Weight | Sustain pulse |
|---|---|---|
| SF1 | 1 | 2 |
| SF2 | 2 | 4 |
| SF3 | 4 | 8 |
| SF4 | 8 | 16 |
| SF5 | 16 | 32 |
| SF6 | 32 | 64 |
| SF7 | 64 | 128 |
| SF8 | 128 | 256 |

As shown in Table 1, the number of sustain pulses applied to each subfield increases as a weight of the subfield increases. When the number of sustain pulses applied to one subfield becomes greater than a predetermined number, a light saturation phenomenon occurs so that a phosphor coated inside the cell is saturated. When the light saturation phenomenon occurs, luminance is not increased in proportion to the number of sustain pulses, thereby causing deterioration of luminance. Therefore, a sustain pulse that compensates luminance deterioration is applied to a subfield where more than a reference number of sustain pulses are applied among the plurality of subfields.

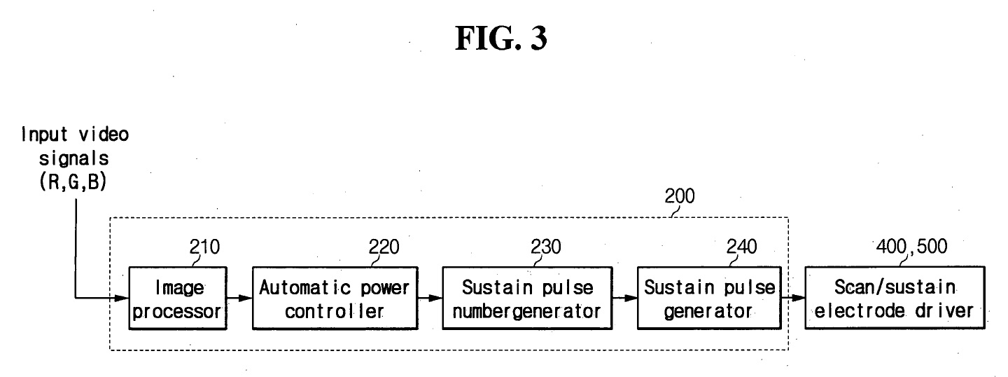

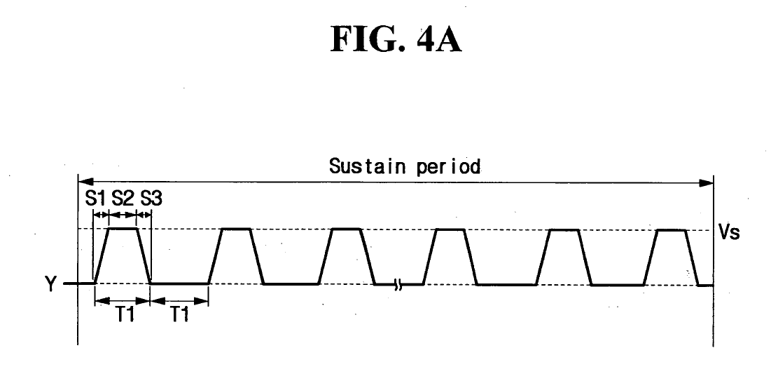

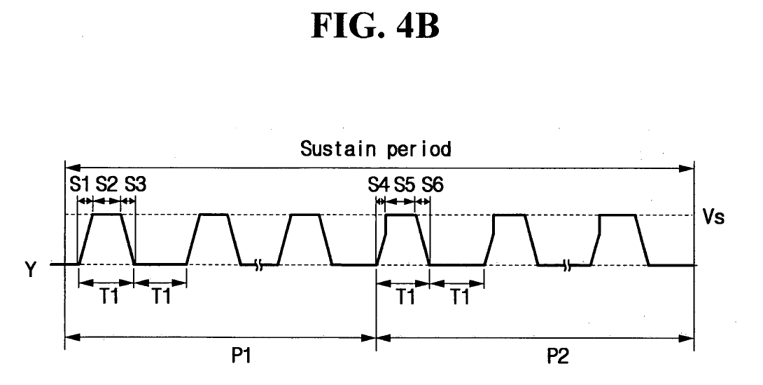

In the following description, a method for compensating the luminance deterioration by applying a different sustain pulse to each subfield according to the number of sustain pulses applied to the subfield will be described in further detail with reference to FIG. 3, FIG. 4A, and FIG. 4B.

FIG. 3 is a block diagram of the controller 200 according to the exemplary embodiment of the present invention, and FIG. 4A and FIG. 4B shows a sustain pulse according to the exemplary embodiment of the present invention. In FIG. 3, unnecessary descriptions of configurations of the controller 200 are omitted for better understanding and ease of description.

As shown in FIG. 3, the controller 200 according to the exemplary embodiment of the present invention includes an image processor 210, an automatic power controller 220, a sustain pulse number generator 230, and a sustain pulse generator 240.

The image processor 210 compensates i-bit input video signal data (R, G, and B) into a j-bit video signal (where j>i) by mapping the data to an inverse gamma curve. In addition, error diffusion data is generated by diffusing an error of a lower j-i bit image of an inverse-gamma-corrected and expanded j-bit image. The error-diffused data is transmitted to the automatic power controller 220. In this case, a video signal input to the image processor 210 is a digital signal, and when an analog video signal is input to the PDP, the analog video signal needs to be converted to digital video signal data by using an analog-to-digital converter (not shown).

The automatic power controller 220 detects a screen load ratio from the error-diffused video signal data. The automatic power controller 220 calculates an automatic power control (APC) level according to the detected screen load ratio and calculates a total number of sustain pulses applied to one frame corresponding to the calculated APC level. For example, the plasma display device applies a relatively smaller number of sustain pulses than a predetermined number of sustain pulses by setting the APC level low when a screen load ratio of an input video signal is high. That is, in general, the PDP 100 consumes a large amount of power, and therefore the automatic power controller 220 decreases brightness of the screen by applying a number of sustain pulses that is smaller than a number of sustain pulses that is originally supposed to be applied so as to reduce the power consumption.

In further detail, the automatic power controller 220 calculates a screen load ratio from the error-diffused data output from the image processor 210. In this case, the screen load ratio can be calculated from an average signal level of video signals of one frame calculated by Equation 1.

$$ASL = \frac{{\sum }_{i = 1}^{N} {R}_{i} + {G}_{i} + {B}_{i}}{3 N} \qquad [ Equation 1 ]$$

In Equation 1, Ri, Gi, and Bi respective denote i-th video signals of a red (R) discharge cell, a green (G) discharge cell, and a blue (b) discharge cell in one frame, and N denotes the number of video signals input during one frame.

The automatic power controller 220 determines a total number of sustain pulses applied to one frame according to the calculated screen load ratio and transmits the total number of sustain pulses to the sustain pulse number generator 230. Herein, the automatic power controller 220 predetermines an APC level corresponding to the screen load ratio. In addition, the automatic power controller 220 may store a total number of sustain pulses corresponding to each APC level in a lookup table in advance, or may calculate a total number of sustain pulses by performing a logic operation on the screen load ratio. In order to prevent power consumption from being increased, the total number of sustain pulses is calculated to be small when the screen load ratio is high. A method for performing the automatic power control is well known to a person of an ordinary skill in the art, and therefore detailed descriptions will be omitted.

The sustain pulse number generator 230 allocates the transmitted total number of sustain pulses of one frame to each subfield according to a weight of the plurality of subfields. The sustain pulse number generator 230 transmits the number of sustain pulses allocated to each subfield to the sustain pulse generator 240.

The sustain pulse generator 240 compares the number of sustain pulses of each subfield with a reference number, and detects a subfield allocated with a number of sustain pulses that is greater than the reference number. The reference number may be set to a number of sustain pulses that causes occurrence of a light saturation phenomenon in a subfield where the number of sustain pulses are applied, thereby causing the luminance deterioration, and this can be experimentally obtained.

During a sustain period of a subfield to which more than the detected reference number of sustain pulses are allocated, the sustain pulse generator 240 outputs a control signal to the scan and sustain electrode drivers 400 and 500 in order to control the scan and sustain electrode drivers 400 and 500 to apply the reference number of first sustain pulses and more than the reference number of second sustain pulses. In this case, the first sustain pulse and the second sustain pulse respectively have a high level voltage and a low level voltage, and a period during which the low level voltage of the first discharge pulse is changed to the high level voltage is greater than a period during which the low level voltage of the second sustain pulses is changed to the high level voltage. That is, the sustain pulse generator 240 transmits the control signal to the scan and sustain electrode drivers 400 and 500 in order to control energy recovery timing (ERC) of the first and second sustain pulses, respectively. The ERC timing refers to timing at which a switch that generates a path through which a high level voltage to the Y and X electrodes in a driving circuit that generates a sustain pulse applied to the Y and X electrodes is turned on.

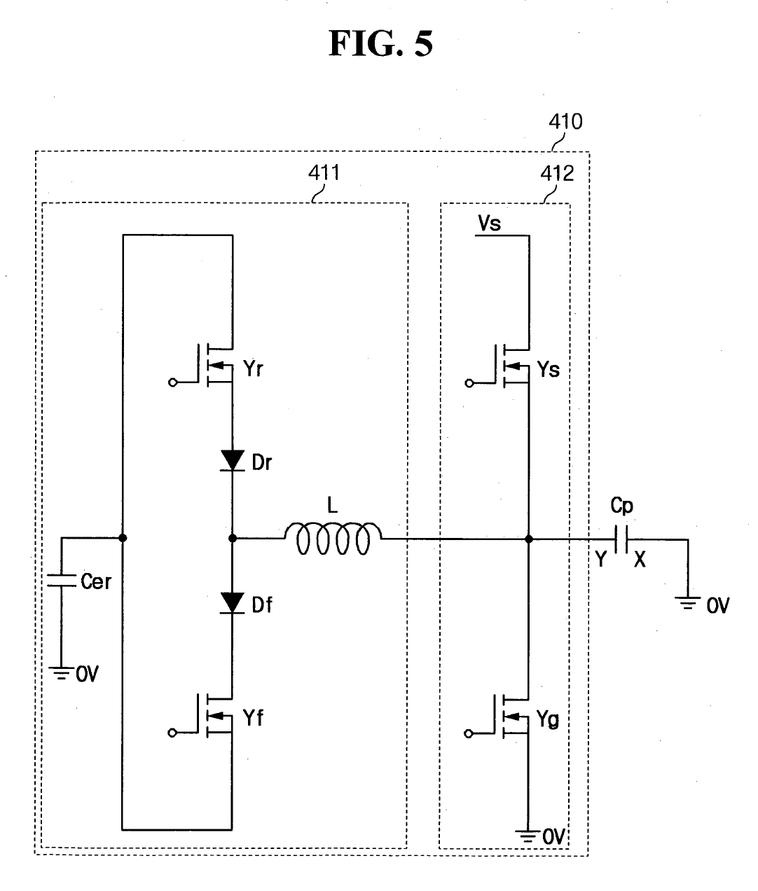

In further detail, the ERC timing of the second sustain pulse according to the exemplary embodiment of the present invention is controlled to apply the high level voltage relatively faster than the first sustain pulses, thereby generating a larger hard switching voltage. Then, a strong sustain discharge is generated in the discharge cell so that the luminance deterioration can be compensated. This will be described in further detail later with reference to FIG. 5 to FIG. 7B.

In a subfield having less than the reference number of sustain pulses, the sustain pulse generator 240 outputs a control signal to the scan and sustain electrode drivers 400 and 500 to control the scan and sustain electrode drivers 400 and 500 to apply a number of first sustain pulses corresponding to the number of sustain pulses allocated during a sustain period of the subfield.

FIG. 4A and FIG. 4B show a sustain pulse according to the exemplary embodiment of the present invention. FIG. 4A and FIG. 4B show sustain discharge wave forms respectively applied during sustain periods of subfields to which less than the reference number of sustain pulses and more than the reference number of sustain pulses are allocated. In this case, although FIG. 4A and FIG. 4B show a sustain pulse applied only to the Y electrode, a sustain pulse applied to the X electrode is the same as the sustain pulse applied to the Y electrode but has an opposite phase.

In further detail, assume that the reference number of sustain pulses that causes the luminance deterioration is 100. In this assumption, the first to sixth subfields SF1 to SF6 where less than 100 sustain pulses are allocated in Table 1 are applied with a number of the first sustain pulses allocated to the respective subfields as shown in FIG. 4A.

In further detail, when the first sustain pulse is applied to the Y electrode, the voltage of the Y electrode is increased to close to the Vs voltage during a period S1, the voltage of the Y electrode is applied with the high level voltage and maintained at the high level voltage during a period S2, and then the voltage of the Y electrode is decreased to close to the low level voltage during a period S3. In this case, a sum of the periods S1, S2, and S3 corresponds to the period T1. After periods S1 to S3, the Y electrode is applied with the low level voltage and maintained at the low level voltage during the next T1 period. As described, the first sustain pulse alternately having the high level voltage and the low level voltage is applied to the Y electrode by a number of sustain pulses allocated to each subfield according to a weight of the corresponding subfield.

Meanwhile, the seventh and eighth subfields SF7 and SF8 where more than 100 sustain pulses are allocated in Table 1 are applied with the second sustain pulse for compensating the luminance deterioration as shown in FIG. 4B. In this case, a period during which less than the reference number of sustain pulses are applied is called a first period P1 and a period during which more than the reference number of sustain pulses are applied is called a second period P2 during sustain periods of the seventh and eighth subfields SF7 and SF8.

During the first period P1, the reference number of first sustain pulses of FIG. 4A are applied to the Y electrode. After that, from a sustain pulse that exceeds the reference number in the second period P2, ERC timing of the second sustain pulse is controlled so that the high level voltage Vs is applied to the Y electrode faster than the sustain pulse applied to the Y electrode during the first period. That is, hard switching is performed by immediately applying the high level voltage (Vs voltage) to the Y electrode before the voltage of the Y electrode increases as in the first sustain pulse. Then, the hard switch is performed in a discharge cell applied with the high level voltage (Vs voltage) faster than other discharge cells, and a stronger sustain discharge is instantly generated. That is, the luminance deterioration can be compensated by the light saturation phenomenon. In this case, like the first sustain pulse, the second sustain pulse also has a high level voltage and a low level voltage, and the high level voltage and the low level voltage are respectively applied during a period T1.

In further detail, the voltage of the Y electrode is increased during a period S4 while the second sustain pulse is applied to the Y electrode during the second period P2. In addition, the high level voltage is applied to the Y electrode before the voltage of the Y electrode is increased to close to the high level voltage and maintain the voltage of the Y electrode at the high level voltage. During a period S6, the voltage of the Y electrode is decreased to the low level voltage. After periods S4 to S6, during the next T1 period, the Y electrode is applied with the low level voltage and maintained at the low level voltage. In this case, a sum of the periods S4, S5, and S6 corresponds to the period T1. The period S4 is less than the period S1, and the period S5 is greater than the period S2. Therefore, a stronger sustain discharge is generated by applying more than the reference number of second sustain pulses so that light saturation phenomenon occurs, thereby compensating the luminance deterioration.

According to the exemplary embodiment of the present invention, in the sustain period of the subfield to which more than the reference number of sustain pulses are applied among the plurality of subfields, the first sustain pulse is applied during the first period P1 and the second sustain pulse that generates the stronger sustain discharge is applied during the second period P2 so as to compensate the luminance deterioration. However, an application order of the second discharge pulse that compensates the luminance deterioration may be variously changed.

For example, not only the first sustain pulse but also at least one second sustain pulse can be applied during the first period P1 of the sustain period of the subfield to which more than the reference number of sustain pulses are allocated.

In further detail, in Table 1, the number of sustain pulses of the seventh subfield according to a weight of the seventh subfield is 128. When the reference number is set to 100, 28 second sustain pulses can be applied to the seventh subfield. Then, a strong discharge can be generated in the discharge cell by applying 28 ERC timing-controlled second sustain pulses among 100 sustain pulses applied to the Y and X electrodes during a first period P1. After that, other sustain pulses applied during the first period P1 and sustain pulses applied during the second period P2 can be applied as the first sustain pulses. In this case, a position of the second sustain pulse applied during the first period P1 can be either a front portion or an end portion of the first period P1.

That is, the number of second sustain pulses to be applied to a subfield to which more than the reference number of sustain pulses are allocated can be calculated in a manner like the above, and the calculated number of second sustain pulses is applied at any point during a sustain period of the subfield so that the luminance deterioration can be compensated.

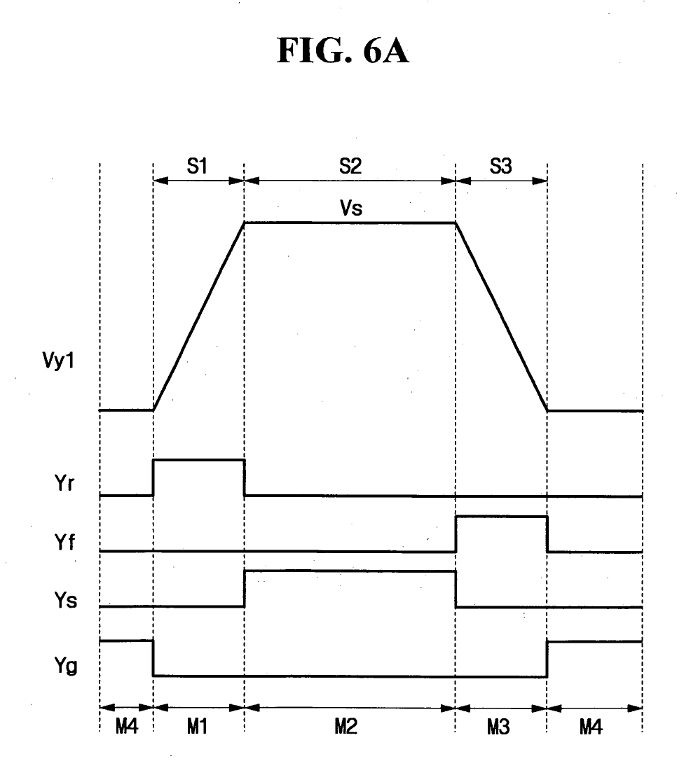

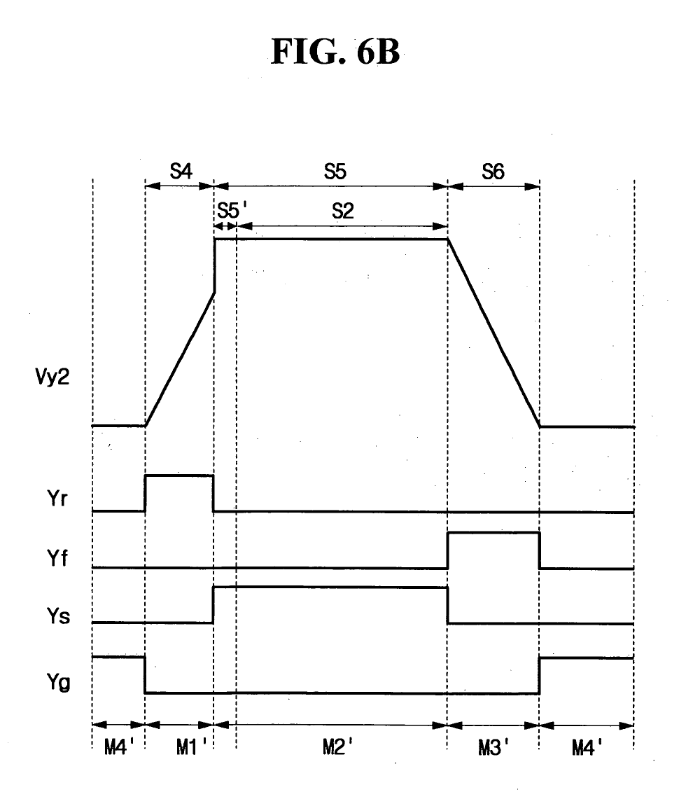

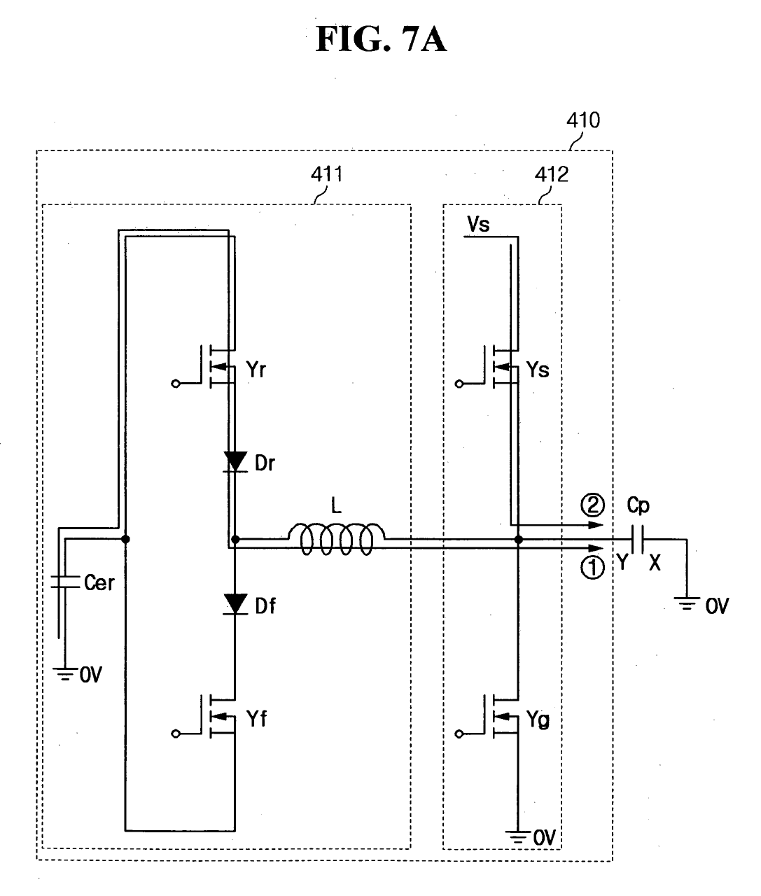

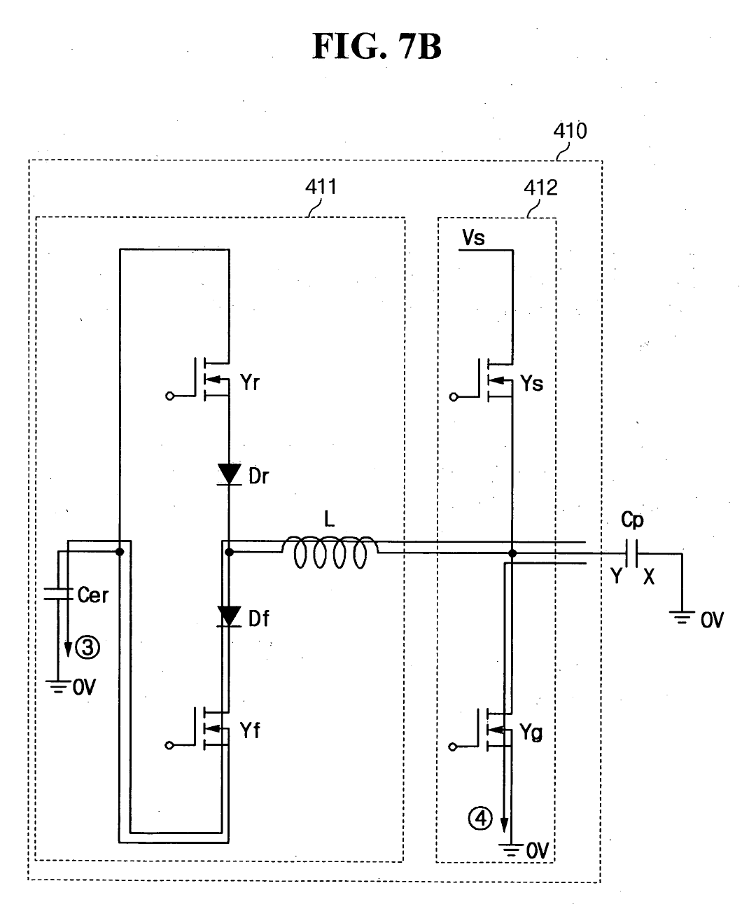

A driving circuit for generating the sustain pulses that compensate the luminance deterioration as shown in FIG. 4A and FIG. 4B and a method for generating the sustain pulse will be described in further detail with reference to FIG. 5, FIG. 6A, FIG. 6B, FIG. 7A, and FIG. 7B.

FIG. 5 shows a sustain driver that generates the sustain pulses according to the exemplary embodiment of the present invention.

In FIG. 5, an n-channel field effect transistor (FET) having a body diode (not shown) is used as a switch, and another switch having the same or similar functions can also be used. In addition, a panel capacitor Cp is equivalent to a capacitance component between the X electrode and the Y electrode. An X electrode of the panel capacitor Cp is connected to the sustain electrode driver 500, and a Y electrode of the panel capacitor Cp is connected to the scan electrode driver 400. It is illustrated in FIG. 5 that a reference voltage (0V in FIG. 5) is connected to the Y electrode since a 0V voltage is applied to the X electrode while the Vs voltage is applied to the Y electrode during a sustain pulse.

In FIG. 5, other driving circuits that are not related to the exemplary embodiment of the present invention are omitted, except for a sustain driver 410 in the scan electrode driver 400 for better understanding and ease of description. In addition, since the sustain electrode driver 500 that generates the sustain pulse applied to the X electrode operates the same as the scan electrode driver 400, operation of only the scan electrode driver 400 will be described.

As shown in FIG. 5, the sustain driver 410 includes a power recovery unit 411 and a sustain discharge voltage supply 412.

The power recovery unit 411 includes transistors Yr and Yf, an inductor L, diodes Dr and Df, and a power recovery capacitor Cer. The sustain discharge voltage supply 412 includes transistors Ys and Yg.

In further detail, the power recovery capacitor Cer of the power recovery unit 411 is charged with a voltage (Vs/2 voltage) between the 0V voltage and the Vs voltage. A first end of the power recovery capacitor Cer is connected to a drain of the transistor Yr and a source of the transistor Yf. The inductor L has a first end connected to a source of the transistor Yr and a drain of transistor Yf and a second end connected to the Y electrode. In this case, the diode Dr is connected between the source of the transistor Yr and the inductor L, and the diode Df is connected between the drain of the transistor Yf and the inductor L. The diode Dr may form a rising path through which a voltage of the panel capacitor Cp is increased when the transistor Yr has a body, and the diode Df may form a falling path through which a voltage of the Y electrode is decreased when the transistor Yf has a body diode. When the transistors Yr and Yf do not have the body diodes, the diodes Dr and Df can be omitted.

With such a connection, the power recovery unit 411 increases the voltage of the Y electrode from the 0V voltage to close to the Vs voltage or decreases the voltage of the Y electrode from the Vs voltage to close to the 0V voltage by using a resonance between the inductor L and the panel capacitor Cp.

In the power recovery unit 410, a connection order between the inductor L, the diode Df, and the transistor Yf can be changed, and a connection order between the inductor L, the diode Dr, and the transistor Yr1 can also be changed. For example, the inductor L may be connected between a node of the transistors Yr and Yf and the power recovery capacitor Cer. In addition, although it is illustrated in FIG. 5 that the inductor L is connected to the node of the transistors Yr and Yf, the inductor L may be connected to a rising path formed by the transistor Yr or a falling path formed by the transistor Yf, respectively.

The transistor Ys of the sustain discharge voltage supply 412 is connected between a power source Vs that supplies the Vs voltage and the Y electrode of the panel capacitor Cp, and the transistor Yg is connected between a ground terminal (0V) that supplies the 0V voltage and the Y electrode of the panel capacitor Cp. In this case, the transistor Ys forms a path through which the Vs voltage is applied to the Y electrode and the transistor Yg forms a path through which the 0V voltage is applied to the Y electrode.

FIG. 6A and FIG. 6B show driving timing of the driving circuit for generating the sustain pulse according to the exemplary embodiment of the present invention, and FIG. 7A and FIG. 7D show current paths for generating the sustain pulse according to the exemplary embodiment of the present invention.

FIG. 6A and FIG. 6B respective show driving timing of the sustain pulse applied during the first period P1 and the second period P1 of FIG. 4B.

In further detail, a driving timing of the first sustain pulse applied during the first period P1 of FIG. 4B is as shown in FIG. 6A. It is assumed that the power recovery capacitor Cer is charged with the Vs/2 voltage before a mode M1 of FIG. 6A is started.

1. Mode 1 M1—Refer to FIGS. 6A and 7A

The transistor is turned on during the mode 1 M1. Then, as shown in FIG. 7A, a current path \textcircled{1} is formed from the power recovery capacitor Cer, through the transistor Yr, the diode Dr, and the inductor L to the Y electrode of the panel capacitor Cp so that a resonance is generated between the panel capacitor Cp and the inductor L. The panel capacitor Cp is charged due to the resonance, as shown in FIG. 6A, a voltage Vy1 of the Y electrode of the panel capacitor Cp is gradually increased from the 0V voltage to close to the Vs voltage during a period S1.

2. Mode 2 M2—Refer to FIGS. 6A and 7A

In the mode 2 M2, the transistor Yr is turned off and the transistor Ys is turned on. Then, as shown in FIG. 7A, a current path \textcircled{2} is formed from the power source Vs through the transistor Ys to the Y electrode of the panel capacitor Cp. That is, as shown in FIG. 6A, the Y electrode is applied with the high level voltage (Vs voltage) and maintained at the high level voltage during a period S2.

3. Mode 3 M3—Refer to FIGS. 6A and 7B

In the mode 3 M3, the transistor Ys is turned off and the transistor Yf is turned on. Then, as shown in FIG. 7B, a current path \textcircled{3} is formed from the Y electrode of the panel capacitor Cp through the inductor L and the transistor Yf to the power recovery capacitor Cer so that a resonance is generated between the inductor L and the panel capacitor Cp. The voltage Vy1 of the Y electrode of the panel capacitor Cp is gradually decreased to the low level voltage (0V) during a period S3 due to the resonance, as shown in FIG. 6A. That is, the panel capacitor Cp is discharged.

4. Mode 4 M4—Refer to FIGS. 6A and 7B

In the mode 4 M4, the transistor Yf is turned off and the transistor Yg is turned on. Then, as shown in FIG. 7B, a current path \textcircled{4} is formed from the Y electrode of the panel capacitor Cp through the transistor Yg to the ground end 0V. That is, as shown in FIG. 6A, the voltage Vy1 of the Y electrode is maintained at the 0V voltage during a period T1.

The above-described mode 1 M1 to mode 4 M4 show a process of applying the first sustain pulse that has been applied during the first period P1 of FIG. 4A to the Y electrode. Although it is not shown in FIG. 6A, the X electrode is applied with the low level voltage during the modes 1 to 3 M1 to M3 of the Y electrode. In addition, during the mode 4 M4, the X electrode is applied with the high level voltage Vs through the same method as in the modes 1 to 3 M1 to M3.

A method for compensating the luminance deterioration by controlling the ERC timing of the second sustain pulse applied during the second period P2 of FIG. 4B will be described in further detail with reference to FIG. 6B, FIG. 7A, and FIG. 7B.

A driving mechanism in FIG. 6B is the same as the driving mechanism of FIG. 6A, except for turn-on timing (i.e., ERC timing) of the transistor Ys that applies the high level voltage Vs to the Y electrode, and therefore the same description will not be repeated. In addition, a mode 1 M1′ to a mode 4 M4′ of FIG. 6B respectively correspond to the mode 1 M1 to the mode 4 M4 of FIG. 6A. It is assumed that the power recovery capacitor Cer is charged with the Vs/2 voltage before the mode 1 M1′ of FIG. 6B is started.

1. Mode 1 M1′—Refer to FIGS. 6B and 7A

In the mode 1 M1′, the transistor Yr is turned on. Then, as shown in FIG. 7A, a current path \textcircled{1} is formed from the power recovery capacitor Cer through the transistor Yr, the diode Dr, and the inductor L to the Y electrode of the panel capacitor Cp so that a resonance is generated between the panel capacitor Cp and the inductor L. The panel capacitor Cp is charged due to the resonance, so that a voltage Vy2 of the Y electrode of the panel capacitor Cp is gradually increased to the Vs voltage.

2. Mode 2 M2′—Refer to FIGS. 6B and 7A

In the mode 2 M2′, the transistor Yr is turned off and the transistor Ys is turned on. Then, as shown in FIG. 7A, a current path \textcircled{2} is formed from the power source Vs through the transistor Ys to the Y electrode of the panel capacitor Cp. That is, the Y electrode is applied with the Vs voltage and maintained at the Vs voltage during a period S5. In this case, the period S5 during which the Vs voltage is applied to the Y electrode is relatively longer than the period S2 during which the Vs voltage is applied to the Y electrode in the mode 2 M2 of FIG. 6A. That is, as shown in FIG. 6B, more than the reference number of sustain pulses turn on the transistor Ys earlier than less than the predetermined number of sustain pulses by a period S5′.

In further detail, the voltage of the Y electrode can be increased to close to the Vs voltage by using the resonance between the inductor L and the panel capacitor Cp in the mode 1 M1′. In this case, the maximum voltage of the voltage Vy2 of the Y electrode is decreased as the mode 2 M2′ (i.e., a turn-timing of the transistor Ys) is started earlier, and accordingly a hard switching voltage is increased. Therefore, the hard switching voltage can be increased by controlling the turn-on timing (i.e., ERC timing) of the transistor Ys to be earlier when applying the second sustain pulse. Thereby, a stronger discharge is generated between the Y electrode and the X electrode so that the light saturation phenomenon occurs, thereby compensating the luminance deterioration.

As in the Y electrode, hard switching can be generated in the driving circuit of the X electrode by controlling the ERC timing when applying the second sustain pulse. That is, in the second period P2 of FIG. 4B, the second sustain pulse is applied to the X and Y electrodes respectively in a way of increasing a hard switching voltage of each electrode so as to generate a stronger discharge, thereby realizing linearity of luminance.

As described above, the hard switching is performed by controlling the ERC timing of the sustain pulse applied during the sustain period of the subfield to which more than the reference number of sustain pulses are applied so that linearity of luminance can be realized regardless of the number of sustain pulses.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display that divides one frame into a plurality of subfields, each having a weight, the driving method comprising:
detecting a first subfield allocated with more than a reference number of sustain pulses during a sustain period among the plurality of subfields;
applying at least N first sustain pulses to the plasma display device during the sustain period of the first subfield (where N is a natural number greater than 1); and
applying at least M second sustain pulse to the plasma display device during the sustain period of the first subfield (where M is a natural number greater than 1),
wherein the first and second sustain pulses alternately have a first voltage and a second voltage that is greater than the first voltage,
wherein the first sustain pulse is increased to a third voltage that is less than the second voltage from the first voltage during a first period and then maintained at the second voltage during a second period,
wherein the second sustain pulse is increased to a fourth voltage that is less than the second voltage from the first voltage during a third period and then maintained at the second voltage during a fourth period, and
wherein the third period is shorter than the first period.

2. The driving method of claim 1, wherein a slope with which the first sustain pulse is increased from the first voltage to the third voltage during the first period equals a slope with which the second sustain pulse is increased from the first voltage to the fourth voltage during the third period.

3. The driving method of claim 2, wherein the fourth voltage is less than the third voltage.

4. The driving method of claim 3, wherein the second period is consecutive to the first period, and the fourth period is consecutive to the third period.

5. The driving method of claim 4, wherein, a number of first sustain pulses applied during a sustain period of a second subfield to which less than the reference number of sustain pulses are allocated among the plurality of subfields corresponds to the number of sustain pulses allocated to the second subfield.

6. The driving method of claim 5, wherein the detecting of the first subfield comprises:
calculating a total number of sustain pulses to be allocated to one frame;
calculating the number of sustain pulses allocated to each subfield from the total number of sustain pulses; and
comparing the number of sustain pulses applied to each subfield with the reference number.

7. The driving method of claim 6, wherein the calculating of the total number of sustain pulses to be allocated to one frame comprises:
calculating a screen load ratio corresponding to a video signal of the frame; and
calculating a total number of sustain pulses to be allocated to the frame according an automatic power control level corresponding to the calculated screen load ratio.

8. The driving method of claim 7, wherein N is the reference number, and M is a number remaining after subtracting the reference number from the number of sustain pulses allocated to the first subfield.

9. A plasma display device comprising:
a plasma display panel (PDP) having a first electrode and a second electrode that performs a sustain discharge operation with the first electrode;
a controller for dividing one frame into a plurality of subfields, and detecting a first subfield to which more than a reference number of sustain pulses are allocated among the plurality of subfields; and
a driver for applying at least N first sustain pulses (where N is a natural number greater than 1) to the PDP and applying at least M second sustain pulses (where M is a natural number greater than 1) to the PDP during a sustain period of the first subfield by control of the controller,
wherein the first and second sustain pulses respectively have a high level voltage and a low level voltage, and a first period during which the first sustain pulse is changed from the low level voltage to the high level voltage is longer than a second period during which the second sustain pulse is changed from the low level voltage to the high level voltage.

10. The plasma display device of claim 9, wherein the driver comprises:
a first switch electrically connected between the first electrode and a first power source that supplies the high level voltage and forming a path through which the high level voltage is applied to the first electrode;
a second switch electrically connected between the first electrode and a second power source that supplies the low level voltage and forming a path through which the low level voltage is applied to the first electrode;
a first capacitor charged with a first voltage between the high level voltage and the low level voltage;
an inductor having a first end electrically connected to the first electrode and a second end electrically connected to the first capacitor;
a third switch electrically connected between the first capacitor and the inductor and forming a path for increasing a voltage of the first electrode; and
a fourth switch electrically connected between the first capacitor and the inductor and forming a path for decreasing the voltage of the first electrode.

11. The plasma display device of claim 10, wherein, during a sustain period of the first subfield, the driver turns on the third switch in the first period and increases the voltage of the first electrode by using a resonance generated between the inductor and the first electrode, turns off the third switch in a third period that is consecutive to the first period and applies the high level voltage to the first electrode when the first sustain pulse is applied, turns on the third switch in the second period and increases the voltage of the first electrode by using the resonance generated between the inductor and the first electrode, and turns off the third switch in a fourth period that is consecutive to the second period and applies the first voltage to the first electrode when the second sustain pulse is applied.

12. A method of driving a plasma display during a sustain period that divides one frame into a plurality of subfields, each having a weight, the driving method comprising:
receiving video signals;
outputting an A address electrode driving control signal, a X sustain electrode driving control signal, and a Y scan electrode driving control signal by a controller based upon the video signals;
applying a high level voltage to the Y scan electrode and a low level voltage to the X sustain electrode during a time period when a first sustain pulse is applied;
applying a low level voltage to the Y scan electrode and a high level voltage to the X sustain electrode during the period T1 when a second sustain pulse is applied;
applying the sustain pulse to the Y scan electrode and the X sustain electrode a repeated number of times that corresponds to a weight of a corresponding subfield of the plurality of subfields.
